(19) United States
(12) Patent Application Publication
(10) Pub. No.: US 2023/0078133 A1
(43) Pub. Date: Mar. 16, 2023

(54) ADVANCED SPECTROSCOPY USING A CAMERA OF A PERSONAL DEVICE

(71) Applicant: Arizona Board of Regents on behalf of the University of Arizona, Tucson, AZ (US)

(72) Inventors: Richard John Koshel, Tucson, AZ (US); Travis Sawyer, Tucson, AZ (US); Justina Bonaventura, Tucson, AZ (US); Thomas Graham Knapp, Tucson, AZ (US)

(21) Appl. No.: 17/931,486

(22) Filed: Sep. 12, 2022

Related U.S. Application Data
(60) Provisional application No. 63/243,034, filed on Sep. 10, 2021.
(60) Provisional application No. 63/243,038, filed on Sep. 10, 2021.

(51) Int. Cl. G01J 3/02

(52) U.S. Cl. CPC G01J 3/0297; G01J 3/0208; G01J 3/0237; G01J 3/0218

(57) ABSTRACT

A system for performing advanced spectrometry using a camera of a personal electronic device. Light from a sample is captured via a light dispersion device that diffracts the light in accordance with the wavelength of that light. A sample spectrum image is captured using a camera of a personal electronic device. Spectral data is extracted from the sample spectrum image and the spectral data is wavelength calibrated by mapping each pixel position in the sample spectrum image to a wavelength. Features are extracted from the wavelength calibrated spectral data and used by classification module, trained on a dataset of features extracted from spectral data of known samples, to classify the sample. In some embodiments, a calibration spectrum image captured from a calibration light source having a known spectrum (e.g., in the same image frame using a bifurcated fiber optic cable) is used to wavelength calibrate the spectral data.

### CROSS-REFERENCE TO RELATED APPLICATIONS

This application claims priority to U.S. Prov. Pat. Appl. Nos. 63/243,034 and 63/243,038, both filed on Sep. 10, 2021, which are hereby incorporated by reference.

### FEDERAL FUNDING

None

### BACKGROUND

Spectroscopy has many practical applications, from performing skin cancer screening by analyzing images of suspicious skin lesions to performing quality control by assessing the quality and homogeneity of assembly line products. However, because spectroscopy requires precise differentiation between nearly identical wavelengths, standard spectroscopy methods require expensive equipment that is precisely calibrated. Accordingly, there is a need for a lower cost system that can be easily and accurately calibrated and perform advanced spectroscopy with a high degree of accuracy and confidence.

### SUMMARY

Disclosed is a system for advanced spectroscopy using the camera of a personal electronic device and a self-calibrating spectrometer. Light from a sample is captured via a light dispersion device that diffracts the light in accordance with the wavelength of that light. A sample spectrum image is captured using a camera of a personal electronic device. Spectral data is extracted from the sample spectrum image and the spectral data is wavelength calibrated by mapping each pixel position in the sample spectrum image to a wavelength. Features are extracted from the wavelength calibrated spectral data and used by classification module, trained on a dataset of features extracted from spectral data of known samples, to classify the sample. In some embodiments, a calibration spectrum image captured from a calibration light source having a known spectrum (e.g., in the same image frame using a bifurcated fiber optic cable) is used to wavelength calibrate the spectral data.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1 is a diagram of an architecture of a system for performing advanced spectroscopy and a self-calibrating spectrometer according to exemplary embodiments.

FIG. 2 is a block diagram of the system for performing advanced spectroscopy and the self-calibrating spectrometer according to exemplary embodiments.

FIG. 3A is a view of an exemplary embodiment wherein a light dispersion device is a diffraction grating.

FIG. 3B is another view of the embodiment of FIG. 3A.

FIG. 3C is a diagram of the diffraction grating of FIGS. 3A and 3B.

FIG. 3D is an image of light dispersed by the diffraction grating of FIGS. 3A through 3C.

FIG. 4A is a view of an exemplary embodiment that includes a bifurcated fiber optic cable.

FIG. 4B is another view of the embodiment of FIG. 4A.

FIG. 4C is an example image captured via the bifurcated fiber optic cable of FIGS. 4A and 4B.

FIG. 5A is a view of an exemplary embodiment that includes a rotating diffraction grating.

FIG. 5B is another view of the rotating diffraction grating of FIG. 5A.

FIG. 5C is another view of the rotating diffraction grating of FIGS. 5A and 5B.

FIG. 5D is another view of the rotating diffraction grating of FIG. 5A through 5C.

FIG. 5E is a first spectral image having a first spectral range and the measured spectrum of the first spectral image.

FIG. 5F is a second spectral image having a second spectral range and the measured spectrum of the second spectral image.

FIG. 5G is a third spectral image having a third spectral range and the measured spectrum of the third spectral image.

FIG. 6A is a view of an exemplary embodiment that includes a plurality of light dispersion devices.

FIG. 6B is another view of the embodiment of FIG. 6A.

FIG. 7 is a flowchart illustrating an image capture process according to an exemplary embodiment.

FIG. 8A is a flowchart of an image processing process according to an exemplary embodiment.

FIG. 8B is an example sample spectrum image.

FIG. 8C is an example spectrum template used to locate spectrum information.

FIG. 8D is an example extracted sample spectrum image.

FIG. 8E is an example of a processed sample spectrum image.

FIG. 8F is a graph of example extracted spectral data.

FIG. 8G is another graph of example extracted spectral data.

FIG. 8H is a graph of the sample spectral data of FIG. 8G and example calibration spectral data.

FIG. 8I is a graph depicting a pixel position-to-wavelength mapping function.

FIG. 8J are examples of first order spectra and second order spectra.

FIG. 9 is a flowchart illustrating a sample classification process according to an exemplary embodiment.

### DETAILED DESCRIPTION

Reference to the drawings illustrating various views of exemplary embodiments is now made. In the drawings and the description of the drawings herein, certain terminology is used for convenience only and is not to be taken as limiting the embodiments of the present invention. Furthermore, in the drawings and the description below, like numerals indicate like elements throughout.

FIG. 1 is a diagram of an architecture 100 of a system 200 for performing advanced spectroscopy and a self-calibrating spectrometer 220 according to exemplary embodiments.

In the embodiment of FIG. 1, the architecture 100 includes a personal electronic device 120 (e.g., a smartphone) in communication with a server 160 via one or more computer networks 170. The server 160 stores data in non-transitory computer readable storage media 180. The personal electronic device 120 includes a camera 124 and a display 128. The camera 124 captures light from a sample 110 and a calibration light source 130 (e.g., via a fiber optic cable 150) that has been passed through a collimating lens 154 and a light dispersion device 140.

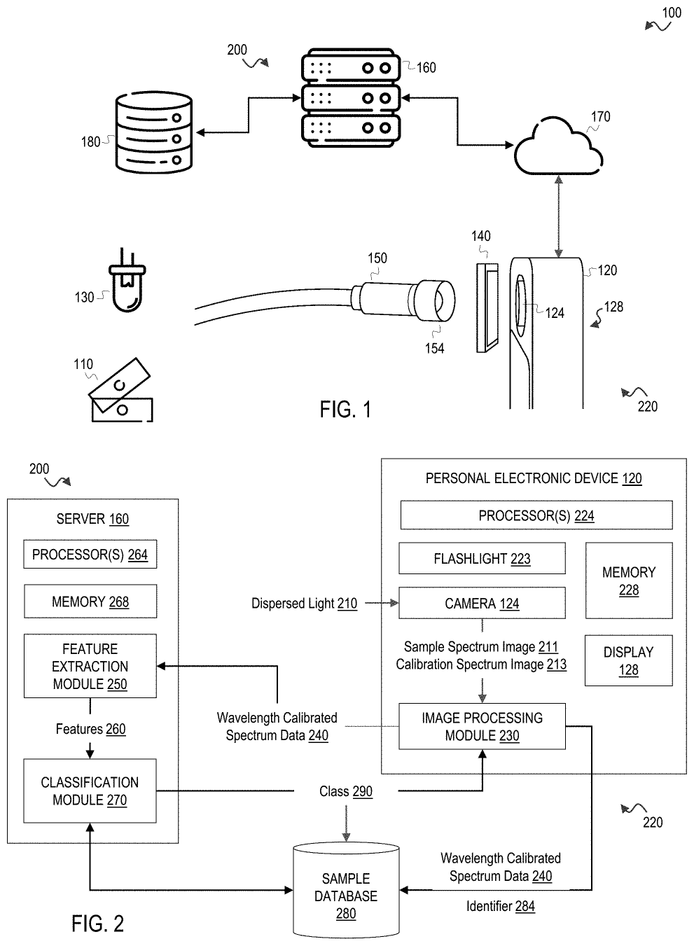

FIG. 2 is a block diagram of the system 200 for performing advanced spectroscopy and the self-calibrating spectrometer 220 according to exemplary embodiments.

As shown in FIG. 2, the server 160 includes one or more hardware computer processors 264, memory 268, a feature extraction module 250, and a classification module 270. The personal electronic device 120 includes one or more hardware computer processors 224, memory 228, and an image processing module 230. In the embodiment of FIG. 2, the personal electronic device 120 also includes a flashlight 223.

The calibration light source 130 may be any device that emits light having a predetermined spectrum that is known to self-calibrating spectrometer 220. The calibration light source 130 may be, for example, the flashlight 223 of the personal electronic device 120 (as described below), one or more light emitting diodes (LEDs), a lamp, etc.

The light dispersion device 140 may be any device that diffracts light at different angles according to the wavelength of that light. For example, the light dispersion device 140 may be a diffraction grating (as described below), a prism, etc. The collimating lens 154 may be any optical device (e.g., a convex lens) that aligns diverging light and emits parallel light.

The personal electronic device 120 may be any hardware computing device having hardware computer processors 224 that execute instructions stored in memory 228 to perform the functions described herein. For example, the personal electronic device 120 may be a smartphone, a tablet computer, a personal computer, a digital camera, etc. The camera 124 may be any hardware device suitably configured to capture light from the sample 110 and the calibration light source 130. For example, the camera 124 may include an image sensor, such as a charge-coupled device (CCD) or complementary metal—oxide—semiconductor (CMOS) active-pixel sensor. The camera 124 may be integrated in the personal electronic device 120 (for example, as shown in FIG. 1) or may be a separate device (e.g., a peripheral camera) in communication with the personal electronic device 120 (e.g., via a wired connection, wireless transmission, a local area network, the transfer of data via removal storage, etc.).

The image processing module 230 may be realized by software instructions stored in memory 228 and executed by the one or more processors 224. While some functions performed by the image processing module (e.g., autocorrection, denoising, etc.) may be native to some personal electronic devices 120 (e.g., smartphones), other functions of the image processing module 230 described herein may be performed by a software application (e.g., a smartphone application) downloaded by the personal electronic devices 120 (e.g., from the server 160, the Apple App Store, Google Play, etc.), stored in memory 228, and executed by the one or more computer processors 224.

The server 160 may be any hardware computing device (e.g., an application server, a web server, etc.) having hardware computer processors 264 that execute instructions stored in memory 268 to perform the functions described herein. The computer readable storage media 180 may include any non-transitory storage medium (e.g., a hard drive, flash memory, etc.). The feature extraction module 250 and the classification module 270 may be realized by software instructions stored in memory 268 and executed by the one or more computer processors 264.

As described in detail below, the camera 124 captures an image of dispersed light 210 from the sample 110 (referred to herein as a sample spectrum image 211) and an image of dispersed light 210 from the calibration light source 130 (referred to herein as a calibration spectrum image 213). The sample spectrum image 211 and the calibration spectrum image 213 are processed by the image processing module 230. A measured spectrum of the sample 110 is extracted from the sample spectrum image 211 and wavelength calibration is performed, for example using the calibration spectrum image 213, to form wavelength calibrated spectrum data 240. In some embodiments, the self-calibrating spectrometer 220 simultaneously captures the sample spectrum image 211 and the calibration spectrum image 213 in the same image frame, enabling the self-calibrating spectrometer 220 to wavelength calibrate the spectrum of the sample 110 more precisely.

The wavelength calibrated spectrum data 240 is stored in a sample database 280 (e.g., on the storage media 180) along with an identifier 284 assigned to the spectrum data 240. The feature extraction module 250 extracts features 260 from the wavelength calibrated spectrum data 240. The classification module 270 classifies the sample 210 as belonging to one of a number of predetermined classes 290 based on the features 260 extracted from the wavelength calibrated spectrum data 240. The server 160 outputs the highest probability class 290, which is stored in the sample database 280 and transmitted to the personal electronic device 120.

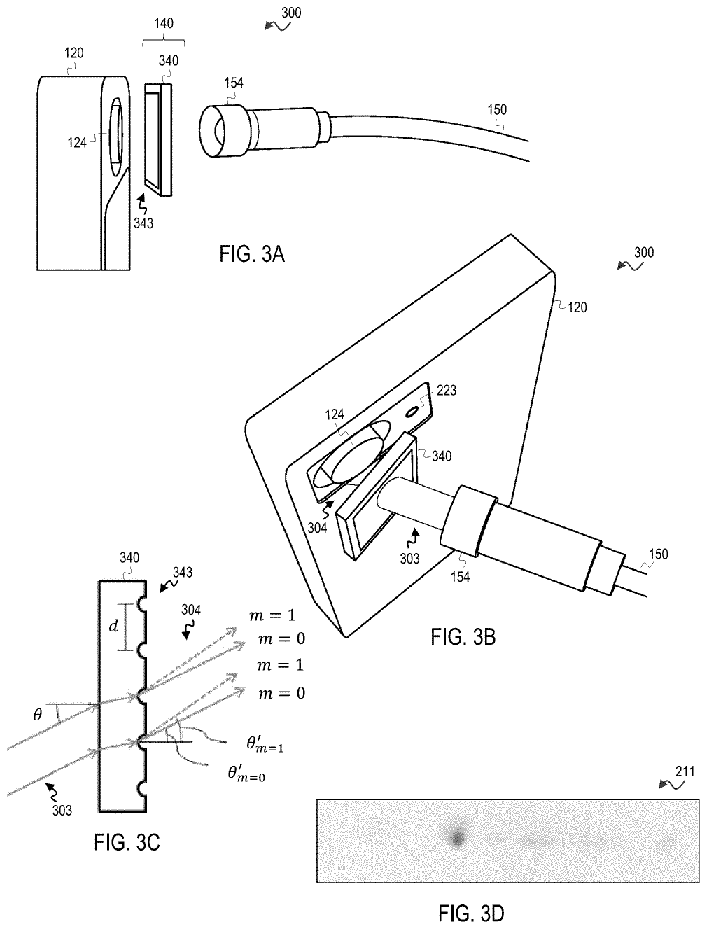

FIGS. 3A through 3C illustrate an exemplary embodiment 300 wherein the light dispersion device 140 is a diffraction grating 340. As shown in FIG. 3A, the diffraction grating 340 includes a grating surface 343. As shown in FIG. 3B, the diffraction grating 340 diffracts parallel light 303 emitted by the collimating lens 154 at different angles according to the wavelength of the parallel light 303 and emits diffracted light 304, which is captured by the camera 124. FIG. 3C is a diagram of the diffraction grating 340, which diffracts the parallel light 303 that is incident on the diffraction grating 340 at angle θ and emits diffracted light 304 at an angle θ′ according to the diffraction equation

d[sin(θ′)−sin(θ)]=mλ

where m is the order of diffraction, d is the grating line spacing of the diffraction grating 340, and λ is the wavelength of the diffracted light.

FIG. 3D is a black-and-white representation of an exemplary sample spectrum image 211. By diffracting the light captured from the sample 110 by an angle θ′ that is proportional to the wavelength θ of that light as described above, the light dispersion device 140 separates the captured light according to wavelength θ. Accordingly, the image of the sample 110 captured by the camera 124 is a spectrum image, wherein the amount of light detected by the camera 124 along the dispersion direction of the light dispersion device 140 (in the example of FIG. 3D, the horizontal direction) is indicative of the wavelength of the light captured from the sample 110. (For the same reason, in an actual color spectrum image 211, the colors of each pixel would vary from violet to red along the along the dispersion direction of the light dispersion device 140.)

### Self-Calibrating Spectrometer

As briefly mentioned above, simultaneously capturing light from the sample 110 and light from the calibration light source 130 in the same image frame enables the self-calibrating spectrometer 220 to wavelength calibrate the spectrum of the sample 110 more precisely.

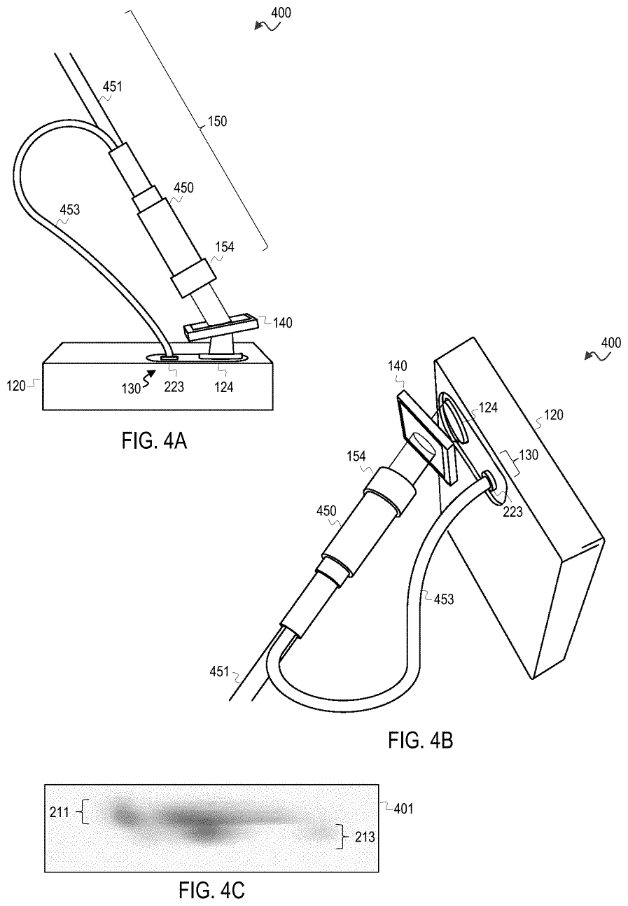

FIGS. 4A and 4B illustrate an exemplary embodiment 400 wherein the self-calibrating spectrometer 220 simultaneously captures the sample spectrum image 211 and the calibration spectrum image 213.

In the embodiment of FIGS. 4A and 4B, the fiber optic cable 150 is a bifurcated fiber optic cable 450 that includes a first fiber 451 and a second fiber 453. The first fiber 451 carries light from the sample 110 and the second fiber 453 that carries light from the calibration light source 130. (As shown in FIGS. 4A and 4B, in some embodiments the calibration light source 130 may be the flashlight 223 of the personal electronic device 120.) The first fiber 451 and the second fiber 453 are aligned at a common end to simultaneously emit the light captured from both the sample 110 and the calibration light source 130 via the collimating lens 154. Accordingly, the bifurcated fiber optic cable 450 enables the self-calibrating spectrometer 220 to simultaneously capture the sample spectrum image 211 and the calibration spectrum image 213 in the same image frame.

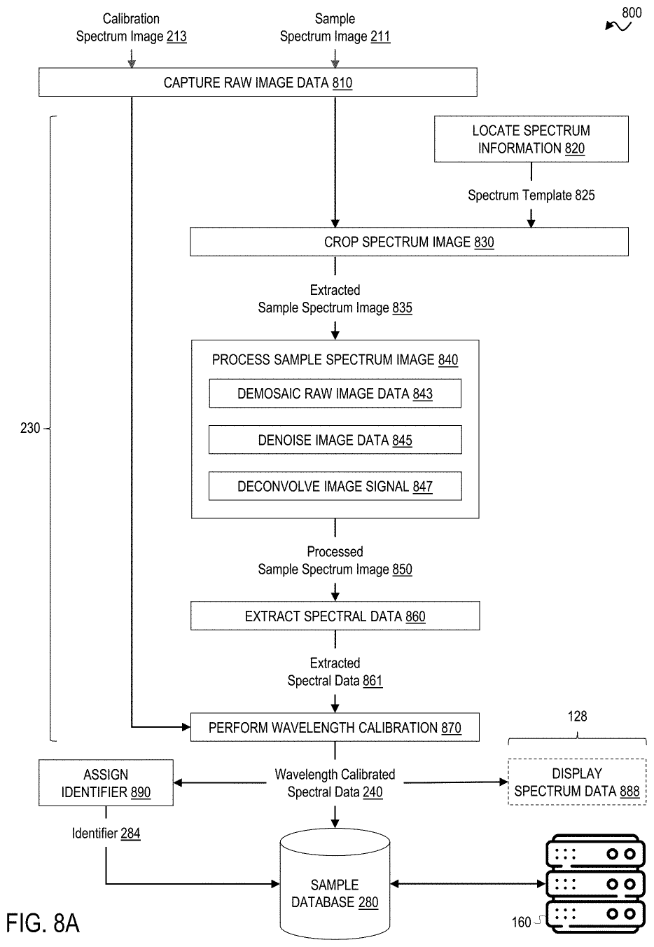

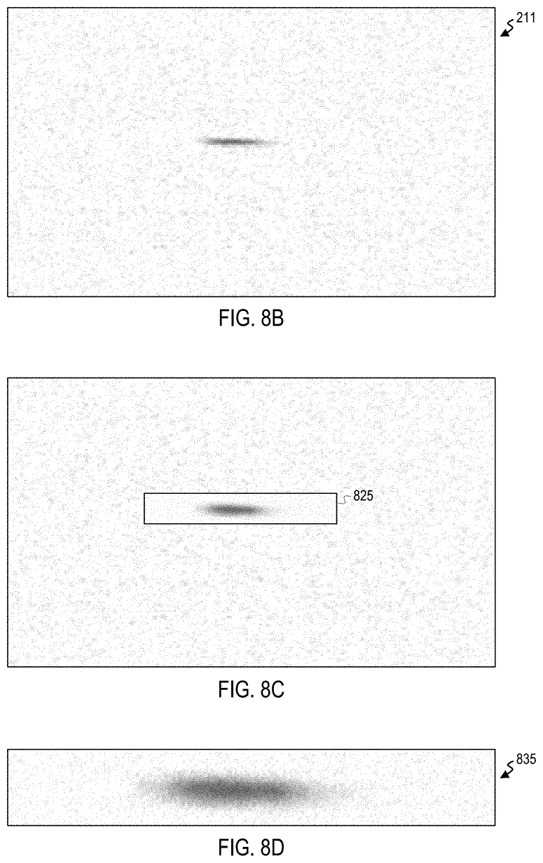

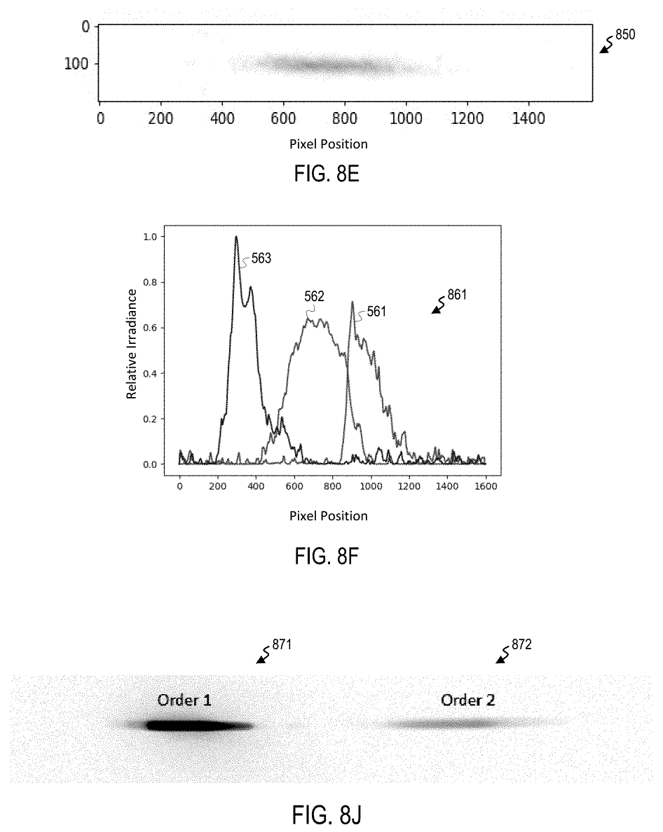

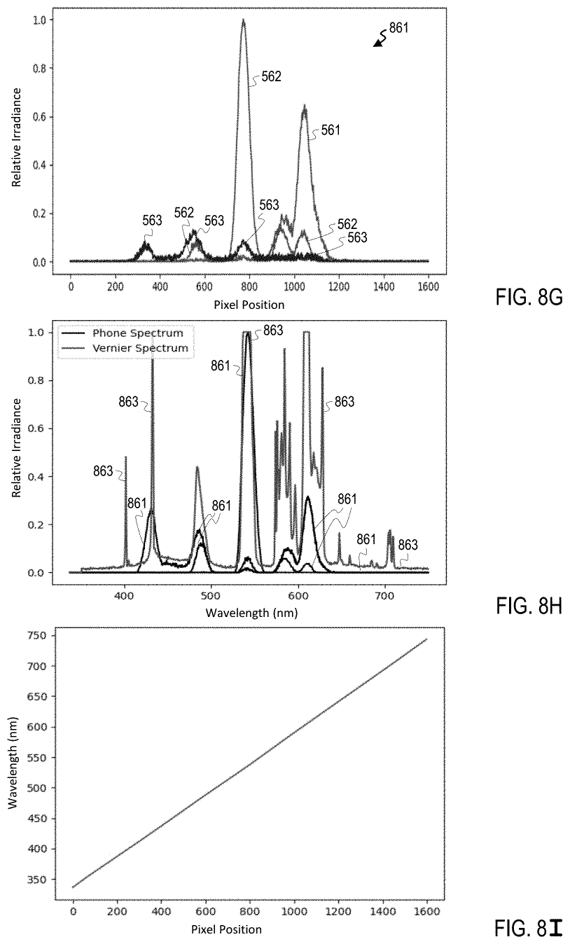

FIG. 4C is an example image frame 401 that includes both the sample spectrum image 211 and the calibration spectrum image 213. As described in detail below with reference to FIGS. 8G through 8I, simultaneously capturing both the sample spectrum image 211 and the calibration spectrum image 213 in the same image frame 401 enables the self-calibrating spectrometer 220 to wavelength calibrate the spectrum of the sample 110 more precisely.

### Varying the Spectral Range by Rotating or Changing the Light Dispersion Device 140

As shown in the dispersion equation above, the diffraction grating 340 diffracts the light captured from the sample 110 (and the calibration light source 130) in accordance with the angle of incidence θ and the grating line spacing d of the diffraction grating 340. Accordingly, adjusting the angle of incidence θ or the grating line spacing d of the diffraction grating 340 adjusts the spectral range of the spectrum image of the sample 110. Meanwhile, certain spectral ranges may enable the system 200 to more accurately classify samples 110 (or certain samples 110). Therefore, in some embodiments, the self-calibrating spectrometer 220 may provide functionality to vary the spectral range of the spectrum image by varying the angle of incidence θ and/or the grating line spacing d of the diffraction grating 340.

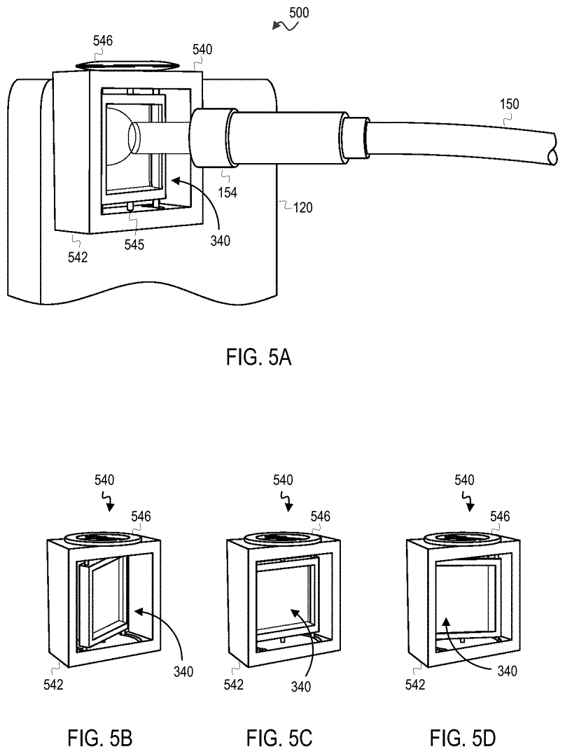

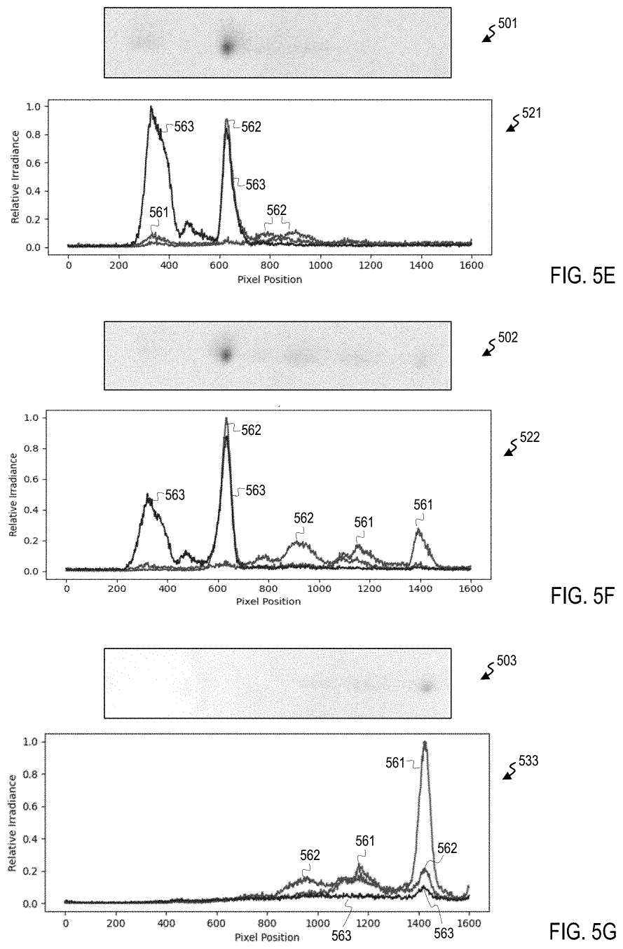

FIGS. 5A through 5G illustrate an embodiment 500 wherein the light dispersion device 140 is a rotating diffraction grating 540. In the embodiment of FIGS. 5A through 5D, the rotating diffraction grating 540 includes a frame 542 and a diffraction grating 340 within the frame 542. The diffraction grating 340 is connected to the top and bottom of the frame 542 via a pin 545 (e.g., through the center axis of the diffraction grating 340 and the center axis of the frame 542). The frame 542 may be affixed to (or held against) the personal electronic device 120 to remain stationary with respect to the personal electronic device 120. The pin 545 and the diffraction grating 140 are rotatable with respect to the frame 542 (e.g., by rotating a dial 546 connected to the pin 545) to rotate the diffraction grating 340 with respect to the camera 124 of the personal electronic device 120.

FIGS. 5E through 5G illustrate how rotating the diffraction grating 340 can change the spectral range of the spectrum image of the sample 110.

FIG. 5E is an example spectrum image 501 having a more blue spectral range and the measured spectral data 521 of the example spectrum image 501, including measured spectral data 521 from a red channel 561, a green channel 562, and a blue channel 563. FIG. 5F is an example spectrum image 502 having a central spectral range and the measured spectral data 522 of the example spectrum image 502. FIG. 5G is an example spectrum image 503 having a more red spectral range and the measured spectral data 523 of the spectral image 503.

By rotating the diffraction grating 340 (for example, as shown in FIGS. 5A), the rotating diffraction grating 540 adjusts the angle of incidence θ, thereby adjusting the spectral range of the sample spectrum image 211. Meanwhile, in some instances, adjusting the spectral range of the sample spectrum image 211 enables the system 200 to better classify the sample 110.

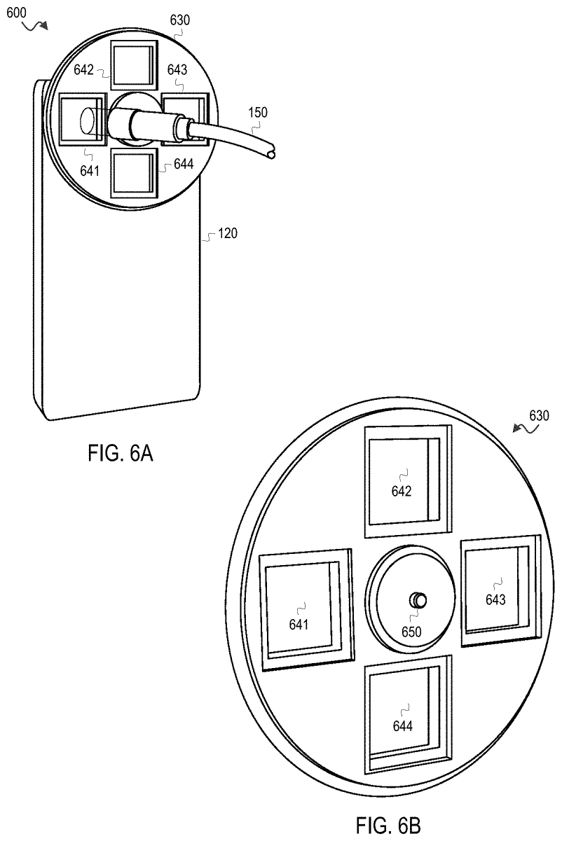

FIGS. 6A and 6B illustrate an exemplary embodiment 600 wherein the spectrometer 220 includes a plurality of light dispersion devices 140.

The embodiment of FIGS. 6A and 6B, for instance, includes a rotating wheel 630 that includes four light dispersion devices 641 through 644. Each of the light dispersion devices 641 through 644 has different diffraction conditions (e.g., grating line spacing d, angle of incidence θ) that each produce a different spectral resolution and/or spectral range. For example, the light dispersion device 641 may be a diffraction grating 340 with a grating line spacing d of 1200 lines/mm and a 5-degree rotation, the light dispersion device 642 may be a diffraction grating 150 with a grating line spacing d of 1200 lines/mm and a 10-degree rotation, the light dispersion device 643 may be a diffraction grating 150 with a grating line spacing d of 800 lines/mm and a 10-degree rotation, and the light dispersion device 643 may be a diffraction grating 150 with a grating line spacing d of 800 lines/mm and a 10-degree rotation.

### Image Capture and Classification

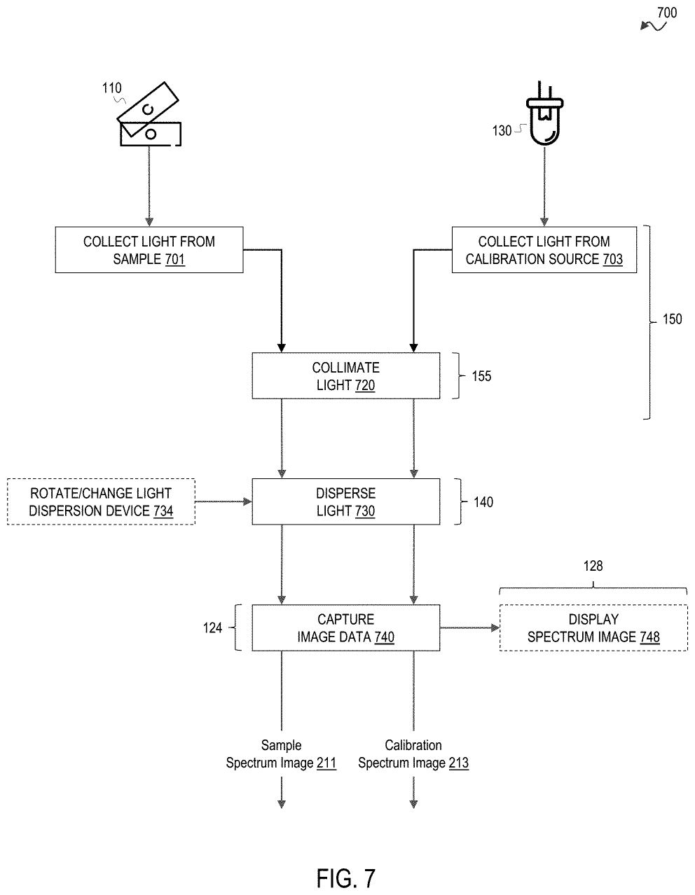

FIG. 7 is a flowchart illustrating an image capture process 700 according to an exemplary embodiment.

As shown in FIG. 7, light is collected from the sample 110 (e.g., via the fiber optic cable 150) in step 701 and light is collected from the calibration light source 130 in step 703. The captured light collimated by the collimating lens 155 in step 720 and dispersed by the light dispersion device 140 in step 730. As described above, the light dispersion device 140 may be rotated or changed to adjust the spectral range and/or spectral resolution of the spectrum image in step 734. A sample spectrum image 211 and a calibration spectrum image 213 are captured by the camera 124 in step 740. The sample spectrum image 211 and the calibration spectrum image 213 are passed to the image processing module 230.

In some embodiments, the system 200 may generate a histogram of the sample spectrum image 211 captured in step 740 to assess exposure levels and focus. The system 200 may automatically set the exposure used by the camera 124 to avoid oversaturation. Additionally or alternatively, the sample spectrum image 211 being captured by the camera 124 may be displayed by an application on the personal electronic device 120 as a preview in step 748 and the system 200 may provide functionality for the user to adjust the exposure time, focus, and/or gain used to capture the dispersed light from the sample 110.

FIG. 8A is a flowchart of an image processing process 800 according to an exemplary embodiment. The image processing process 800 may be performed by the image processing module 230, for example in response to instructions output by an application downloaded to and executed by the personal electronic device 120. As one of ordinary skill in the art would recognize, some image processing steps of FIG. 8A may be optional and may not necessarily be performed in the order show in FIG. 8A and described below.

As shown in FIG. 8A, the sample spectrum image 211 and the calibration spectrum image 213 are captured and saved, for example in RAW format, in step 810. (FIG. 8B is a black-and-white representation of an example sample spectrum image 211.) Spectrum information in the sample spectrum image 211 is located in in step 820, for example by matching the spectrum information in the captured sample spectrum image 211 to a spectrum template 825 (e.g., using autocorrelation). (FIG. 8C is an example spectrum template 825 used to locate the spectrum information in the example sample spectrum image 211 of FIG. 8B.) The sample spectrum image 211 may be cropped around the spectrum template 825 to form an extracted sample spectrum image 835 that includes only the portion of the sample spectrum image 211 that includes spectrum information in step 830. (FIG. 8D is a black-and-white representation of an example extracted sample spectrum image 835 extracted from the example sample spectrum image 211 of FIG. 8A.) The spectrum template 825 is the estimated location of spectrum information within the sample spectrum image 211. For example, the system 200 may store a spectrum template 825 generated by capturing a spectrum image of a broad spectrum and creating a template that includes the spectrum information captured from the broad spectrum. The spectrum template 825 may depend on which of a plurality of grating characteristics (e.g., angle of incidence 0, grating line spacing d) used to capture the sample spectrum image 211. For instance, the system 200 may store a plurality of grating characteristics and a spectrum template 825 used to extract spectrum information in sample spectrum images 211 captured using each of the grating characteristics.

The extracted sample spectrum image 835 is processed to form a processed sample spectrum image 850 in step 840. (FIG. 8E is a black-and-white representation of an example of a processed sample spectrum image 850 generated by processing the example extracted sample spectrum image 835 of FIG. 8D.) For example, RAW format images are stored as multiple single-channel images (e.g., a single-channel image for each of the blue, red, and green channels). Accordingly, in embodiments where captured images are stored in RAW format, the raw image data may be converted to a multi-channel sample spectrum image 850 by applying a demosaicing algorithm in step 843. The image processing module 230 may perform noise reduction in step 845 (e.g., by filtering the spectrum image using a convolutional averaging filter, a median filter, and/or linear or Lasso regression, etc.). Because the end of the fiber optic cable 150 is two-dimensional (rather than a point light source), the image processing module 230 may also perform deconvolution in step 847 (e.g., with a circular kernel) to sharpen the signal to account for the point spread function of the end of the fiber optic cable 150. The system 200 may provide functionality for the user to select the method used by the system 200 to preprocess the extracted sample spectrum image 835. Additionally, the image processing module 230 may average multiple sample spectrum images 835 of the sample 110 captured in series.

Spectral data 861 is extracted from the processed sample spectrum image 850 in step 860. (FIG. 8F is example spectral data 861, including spectral data 861 extracted from the red channel 561, the green channel 562, and the blue channel 563.) As described above, because the light dispersion device 140 diffracts light from the sample 110 according to wavelength, that light is captured by the camera 124 at locations along the dispersion direction of the light dispersion device 140 that are indicative of the wavelength of that light. Accordingly, to identify the wavelengths of the light captured from the sample 110, the system 200 calculates the amount of light captured at each location along the dispersal direction of the light dispersion device 140 (in the example of FIGS. 8E and 8F, the horizontal direction). To do so, the system sums the pixel values for each column of pixels orthogonal to the dispersion direction (in the example of FIG. 8E, the vertical direction) at each location along the dispersal direction (in the example of FIGS. 8E and 8F, the horizontal direction). The pixel value sums for each location along the dispersion direction may be normalized (e.g., between 0 and 1) to determine the relative irradiance at each pixel position along the dispersion direction (i.e., the irradiance at each pixel position along the dispersion direction of the processed sample spectrum image 850 relative to the irradiance of the processed sample spectrum image 850 at all of the pixel positions along the dispersion direction).

Because the relative irradiance of the extracted spectral data 861 at each pixel position along the dispersion direction is indicative of the wavelength of light captured from the sample 211 as described above, the system 200 can identify the wavelength of the light from the sample 211 by mapping each pixel position along the dispersion direction to a wavelength. Accordingly, the extracted spectral data 861 is wavelength calibrated in step 870 to map each pixel position to a wavelength and generate wavelength calibrated spectral data 240.

In some embodiments, the self-calibrating spectrometer 220 uses the calibration spectrum image 213 of the calibration light source 130 to wavelength calibrate the extracted spectral data 861. As described above, the calibration light source 130 emits light having a predetermined spectrum that is known to the self-calibrating spectrometer 220. Accordingly, as shown in FIG. 8G through 8I, the self-calibrating spectrometer 220 can extract calibration spectral data 863 from the calibration spectrum image 213 (using the same process for extracting the sample spectral data 861 from the sample spectrum image 211), match the calibration spectral data 863 to the known spectrum of the calibration light source 130, map each pixel position in the calibration spectrum image 213 to each wavelength in the known spectrum of the calibration light source 130, and apply the same pixel position-to-wavelength mapping to the sample spectral data 861 extracted from the sample spectrum image 211.

FIG. 8G is a graph of example sample spectral data 861 at each pixel position of a sample spectrum image 211, including spectral data 861 from the red channel 561, the green channel 562, and the blue channel 563. FIG. 8H is the example sample spectral data 861 of FIG. 8G and an example calibration spectral data 863. As described above, because the spectrum of the light emitted by the calibration light source 130 is known, the self-calibrating spectrometer 220 can match the calibration spectral data 863 to the known spectrum of the calibration light source 130. For instance, the peaks in the calibration spectral data 863 in the calibration spectrum image can be matched to peaks in the known spectrum of the calibration light source. Accordingly, the pixel positions of those peaks in the calibration spectrum image 213 can be mapped to the wavelengths of those peaks in the known spectrum of the calibration light source 130 to generate a pixel position-to-wavelength mapping, for example as shown in FIG. 8I.

In embodiments where the sample spectrum image 211 and the calibration spectrum image 213 are captured using the same grating characteristics, the same distance between pixel positions in both the sample spectrum image 211 and the calibration spectrum image 213 will both correspond to the same difference in wavelength. Accordingly, in those embodiments, each pixel position of the sample spectral data 861 can be mapped to a wavelength using the same scale as the pixel position-to-wavelength mapping of the calibration spectral data 863.

Additionally, in embodiments where the sample spectrum image 211 and the calibration spectrum image 213 are captured simultaneously in the same image frame (e.g., using the bifurcated fiber optic cable 450 of FIGS. 4A and 4B), the self-calibrating spectrometer 220 can more precisely map each pixel position of a wavelength. Referring back to FIG. 4C, for instance, the sample spectrum image 211 and the calibration spectrum image 213 are both captured in the same image frame 401. Accordingly, the pixel positions in both the sample spectral data 861 and the calibration spectral data 863 can be mapped to wavelengths using the same scale as described above. Additionally, the first and second fibers 451 and 453 of the bifurcated fiber optic cable 450 are aligned in a direction (in this example, vertically) orthogonal to the dispersal direction of the light dispersion device 150, such that the light having the same wavelength from both the sample 110 and the calibration light source 130 are aligned. Accordingly, in those embodiments, each pixel position of the calibration spectrum image 213 can be mapped to a wavelength as described above and the same pixel position of the sample spectrum image 211 can be mapped to the same wavelength.

In other embodiments, a manual calibration mapping—captured, for example, using a known narrowband light source (e.g., a Helium or Argon lamp)—may be applied to the sample spectrum image 211. In yet other embodiments, crossing points of the red and green color channels and the blue and green color channels may be found and mapped onto the respective crossing points of the known or measured Bayer wavelength response function. Finally, in other embodiments with certain grating configurations, the first order spectra 871 and second order spectra 872 may be captured (e.g., as shown in FIG. 8J) and calibration may be performed using the known relationship between the first order spectra 861 and second order spectra 862. In any of the embodiments described above, the wavelength-calibrated spectrum may be merged from the RGB channels 561-563, for example using a weighted average of RGB channels 561-563 or a least squares optimization using the known or measured Bayer wavelength response function as a reference weighted by the distance from the median.

Using the image processing process 800 described above, the personal electronic device 120 extracts and wavelength calibrates spectral data 861 from the sample spectrum image 211 of the sample 110 to form a wavelength calibrated spectral data 240, which is stored in the sample database 280 along with an identifier 284 generated in step 890 to identify the wavelength calibrated sample spectrum image 240.

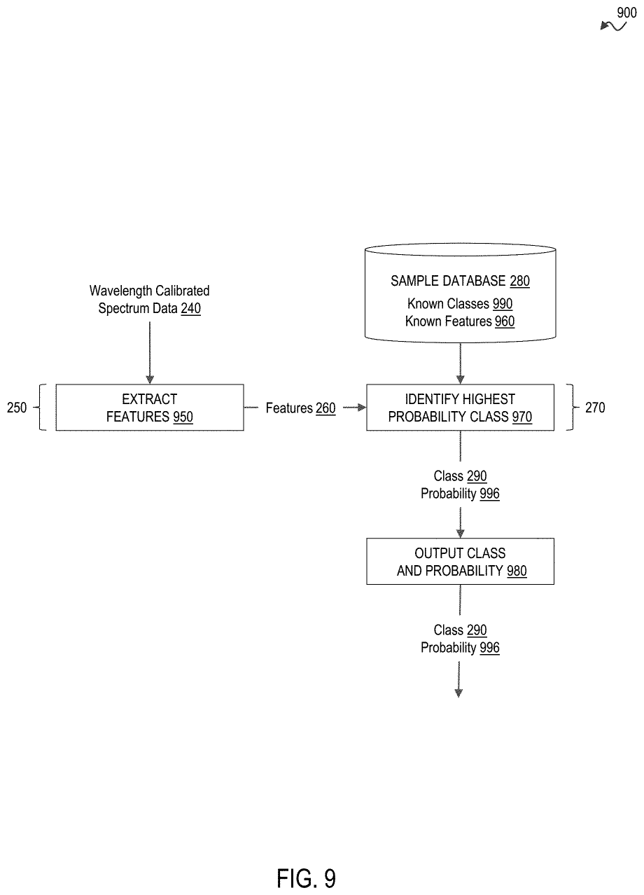

FIG. 9 is a flowchart illustrating a sample classification process 900 according to an exemplary embodiment.

As shown in FIG. 9, features 260 are extracted from the wavelength calibrated spectrum data 240 by the feature extraction module 250 of the server 170 in step 950, for example using spectral band selection, principal component analysis, full spectrum input, etc. The features 260 may also be extracted from a conventional image of the sample 100 (e.g., captured by the camera 124 of the personal electronic device 120 without the lens and the dispersive element 140), for example using texture analysis, morphological analysis, full image input.

The extracted features 260 are provided to the classification module 270, which is trained on a dataset (stored in the sample database 280) of features 960 extracted from spectral data of spectrum images of known samples, each known sample having been pre-identified as belonging to at least one of a number of predetermined classes 960. The classification module 270, having been trained on the dataset of known samples, determines a probability 996 that the sample 110 in the captured image belongs to each of the predetermined classes 290 in step 970. The classification module 270 uses machine learning or a statistical classification technique to identify the one or more predetermined classes 290 having the highest probability 996 that the sample 110 in the captured image belongs to that class 290 (and the probability 996 that the sample 110 belongs to that class 290). The classification module 270 may use, for example, a neural network, a support vector machine, linear discriminant analysis, etc. The highest probability class 290 (and, in some embodiments, the probability 996 that that the sample 110 belongs to that class 290) is output for transmittal to the personal electronic device (e.g., via the computer networks 170) in step 980.

While the feature extraction module 250 and the classification module 270 are shown in FIG. 2 as separate elements, in some embodiments a single element (e.g., a neural network) may both extract the features 260 and identify the highest probability class 290.

The system 200 may also provide functionality for the user to capture a conventional image of the sample 110 using the camera 124 of the personal electronic device 120 and store the conventional image of the sample 110 along with the class 290 of the sample determined by the classification module 270 (as well as, in some embodiments, the date of the image, the location of the image, and/or other metadata).

The system 200 has a number of practical applications. The system 200 may be used to perform skin cancer screening. For example, images of suspicious skin lesions captured using personal electronic devices 110 may be provided to a classification module 270 trained on a dataset of images of skin lesions having been pre-classified 290 as either malignant or benign. The system 200 may also be used for performing quality control, for example assessing the quality and homogeneity of assembly-line produced items. The system 200 may also be used to perform color matching, for example in a commercial environment, by capturing the spectrum of an object's color and using the classification module 270 to compare the spectrum of the object's color to the spectra of other objects.

While preferred embodiments have been described above, those skilled in the art who have reviewed the present disclosure will readily appreciate that other embodiments can be realized within the scope of the invention. Accordingly, the present invention should be construed as limited only by any appended claims.

What is claimed is:

1. A method for performing advanced spectrometry using a camera of a personal electronic device, comprising:
capturing, by a fiber optic cable, light from a sample;
passing the light captured from the sample through a collimating lens and a light dispersion device that diffracts the light from the sample at angles along a dispersion direction in accordance with the wavelength of the light from the sample;
capturing a sample spectrum image, by a camera of a personal electronic device, by capturing an image of the dispersed light from the sample;
extracting sample spectral data from the sample spectrum image, the sample spectral data comprising an amount of light captured by the camera at each of a plurality of pixel positions along the dispersion direction of the light dispersion device;
wavelength calibrating the sample spectral data by mapping each pixel position to a wavelength;
extracting features from the wavelength calibrated spectral data;
providing the extracted features to a classification module trained on a dataset of features extracted from spectral data of known samples, each known sample having been pre-identified as belonging to one of a plurality of predetermined classes; and
determining, by the classification model, a probability that the sample belongs to each of the predetermined classes.

2. The method of claim 1, wherein the classification module is trained to generate a machine learning model classify the sample using the features extracted from the spectral data extracted from the sample spectrum image.

3. The method of claim 1, further comprising:
capturing a calibration spectrum image by capturing light, dispersed by the light diffraction device, from a calibration light source that emits light having a known spectrum;

4. The method of claim 3, wherein:
the light dispersion device is a diffraction grating having a number of potential grating characteristics; and
the sample spectrum image and the calibration spectrum image are captured via the diffracting grating using the same grating characteristics.

5. The method of claim 3, further comprising:
extracting calibration spectral data from the calibration spectrum image; and
wavelength calibrating the sample spectral data by:
matching the calibration spectral data to the known spectrum of the calibration light source;
identifying a pixel position-to-wavelength mapping by mapping each pixel position of the calibration spectrum image along the dispersion direction to a wavelength of the known spectrum of the calibration light source; and
mapping each pixel position of the sample spectral data to a wavelength based on the pixel position-to-wavelength mapping.

6. The method of claim 5, wherein the camera simultaneously captures the sample spectrum image and the calibration spectrum image in a single image frame.

7. The method of claim 6, wherein the fiber optic cable is a bifurcated fiber optic cable having a first fiber that carries light from the sample and the second fiber that carries light from the calibration light source, the first fiber and the second fiber being aligned at a common end to simultaneously emit the light captured from both the sample and the calibration light source via the collimating lens.

8. The method of claim 7, wherein:
the first fiber and the second fiber are aligned at the common end orthogonal to the dispersion direction; and
the sample spectrum image and the calibration spectrum image are aligned orthogonal to the dispersion direction.

9. The method of claim 8, wherein each pixel position of the sample spectrum image is mapped to the wavelength mapped to the pixel position of the calibration spectrum image aligned with the pixel position of the sample spectrum image.

10. The method of claim 7, wherein the calibration light source is a flashlight of the personal electronic device.

11. A system for performing advanced spectrometry using a camera of a personal electronic device, comprising:
a fiber optic cable that captures light from a sample and emits the light captured from the sample via a collimating lens;
a light dispersion device that diffracts the light from the sample along a dispersion direction in accordance with the wavelength of the light from the sample;
a personal electronic device that:
captures a sample spectrum image of the dispersed light from the sample;
extracts sample spectral data from the sample spectrum image, the sample spectral data comprising an amount of light captured by the camera at each of a plurality of pixel positions along the dispersion direction of the light dispersion device; and
wavelength calibrates the sample spectral data by mapping each pixel position to a wavelength;
a feature extraction module that extracts features from the wavelength calibrated spectral data; and
a classification module, trained on a dataset of features extracted from spectral data of known samples that are each pre-identified as belonging to one of a plurality of predetermined classes, that determines a probability that the sample belongs to each of the predetermined classes.

12. The system of claim 11, wherein the classification module is trained to generate a machine learning model classify the sample using the features extracted from the spectral data extracted from the sample spectrum image.

13. The system of claim 11, wherein the personal electronic device captures a calibration spectrum image by capturing light, dispersed by the light diffraction device, from a calibration light source that emits light having a known spectrum;

14. The system of claim 13, wherein:
the light dispersion device is a diffraction grating having a number of potential grating characteristics; and
the sample spectrum image and the calibration spectrum image are captured via the diffracting grating using the same grating characteristics.

15. The system of claim 13, wherein the personal electronic device:
extracts calibration spectral data from the calibration spectrum image; and
wavelength calibrates the sample spectral data by:
matching the calibration spectral data to the known spectrum of the calibration light source;
identifying a pixel position-to-wavelength mapping by mapping each pixel position of the calibration spectrum image along the dispersion direction to a wavelength of the known spectrum of the calibration light source; and
mapping each pixel position of the sample spectral data to a wavelength based on the pixel position-to-wavelength mapping.

16. The system of claim 15, wherein the camera simultaneously captures the sample spectrum image and the calibration spectrum image in a single image frame.

17. The system of claim 16, wherein the fiber optic cable is a bifurcated fiber optic cable having a first fiber that carries light from the sample and the second fiber that carries light from the calibration light source, the first fiber and the second fiber being aligned at a common end to simultaneously emit the light captured from both the sample and the calibration light source via the collimating lens.

18. The system of claim 17, wherein:
the first fiber and the second fiber are aligned at the common end orthogonal to the dispersion direction; and
the sample spectrum image and the calibration spectrum image are aligned orthogonal to the dispersion direction.

19. The system of claim 18, wherein each pixel position of the sample spectrum image is mapped to the wavelength mapped to the pixel position of the calibration spectrum image aligned with the pixel position of the sample spectrum image.

20. The system of claim 17, wherein the calibration light source is a flashlight of the personal electronic device.
